(19) United States
(12) Patent Application Publication
(10) Pub. No.: US 2017/0328105 A1
(43) Pub. Date: Nov. 16, 2017

(54) HORIZONTAL GARAGE DOOR ASSEMBLY

(71) Applicant: Contour Closures, Inc., Catharpin, VA (US)

(72) Inventor: Tyler MALEJKO, Catharpin, VA (US)

(73) Assignee: Contour Closures, Inc., Catharpin, VA (US)

(21) Appl. No.: 15/587,999

(22) Filed: May 5, 2017

Related U.S. Application Data
(60) Provisional application No. 62/334,580, filed on May 11, 2016.
(60) Provisional application No. 62/372,514, filed on Aug. 9, 2016.

(51) Int. Cl. E05D 15/06; E05D 15/12; E05F 15/646; E06B 3/48; E05F 11/04

(52) U.S. Cl. CPC E05D 15/0608; E06B 3/485; E05F 11/04; E05F 15/646; E05D 15/12; E05Y 2900/106

(57) ABSTRACT

A horizontal garage door assembly includes a plurality of panels, which are pivotally connected at adjacent side edges. A top rail receives the plurality of panels and includes a first straight portion, a curved portion, and a second straight portion. A motor is positioned at a first end of the first straight portion, a tensioning mechanism is disposed on a first panel, a gear mechanism is positioned at a second end of the first straight portion. A connecting band connects the motor, the gear mechanism, and the tensioning mechanism to form a loop along a length of the top rail. The motor drives the connecting band such that the plurality of panels moves between a closed position, in which the plurality of panels is substantially received in the first straight portion, and an open position, in which the plurality of panels is substantially received in the second straight portion.

### CROSS-REFERENCE TO RELATED APPLICATIONS

This application claims the benefit of U.S. Provisional Application No. 62/334,580, filed May 11, 2016; and the benefit of U.S. Provisional Application No. 62/372,514, filed Aug. 9, 2016; the entire disclosures of both of which are hereby incorporated by reference in their entirety.

### BACKGROUND

The present disclosure relates to garage door assemblies. In particular, the present disclosure relates to horizontal garage door assemblies.

Typical residential garage doors, formed by a plurality of panels connected at horizontally-extending side edges, open vertically through the use of a motor and belt or chain system. Due to the vertical movement of the garage door, the size of the panels is limited as the power capacity of the motor limits the ability of the system to lift the panels from a closed position to an open position. This, in turn, limits the size of an opening that can be provided in a garage enclosure. If a larger garage door is desired, costs are greatly increased as motor capacity, counter balances, and springs must be increased to lift the larger panels. The panels must also be reinforced to support the increased length of the panels to prevent sagging when the panels are in the open position. In addition, because the motor must lift the panels from the closed position to the open position against gravity, the risk of injury may increase in cases when malfunction occurs. However, vertically-opening garage doors are still in widespread use in North America due to strict safety standards such as Underwriters Laboratories (UL) standards.

### SUMMARY

The present disclosure provides a garage door assembly that may reduce the safety risks posed by garage door assemblies having vertically-opening panels and the increase in costs associated with an increase in an opening of a garage enclosure by providing a garage door assembly having panels that open horizontally.

In certain embodiments, a horizontal garage door assembly similarly includes a plurality of panels. Each of the plurality of panels has a top edge and a bottom edge and a pair of vertically-extending side edges connecting the top edge and the bottom edge. Adjacent panels are pivotally connected at adjacent side edges. The garage door assembly further includes a top rail positioned above the top edges of the plurality of panels and configured to receive the plurality of panels. The top rail includes a first straight portion, a curved portion, and a second straight portion. The curved portion connects the first straight portion and the second straight portion. The garage door assembly further includes a motor positioned at a first end of the first straight portion, a tensioning mechanism disposed on a first panel, a gear mechanism positioned at a second end of the first straight portion, and a connecting band connected to the motor and the gear mechanism and attached to the tensioning mechanism to form a loop along a length of the top rail. The motor is configured to drive the connecting band such that the plurality of panels moves between a closed position and an open position. In the closed position, the plurality of panels is substantially received in the first straight portion. In the open position, the plurality of panels is substantially received in the second straight portion.

In certain embodiments, a horizontal garage door assembly similarly includes a plurality of panels. Each of the plurality of panels has a top edge and a bottom edge and a pair of vertically-extending side edges connecting the top edge and the bottom edge. Adjacent panels are pivotally connected at adjacent side edges. The garage door assembly further includes a top rail positioned above the top edges of the plurality of panels and configured to receive the plurality of panels. The top rail includes a first straight portion, a curved portion, and a second straight portion. The curved portion connects the first straight portion and the second straight portion. The garage door assembly further includes a transport mechanism disposed on a first panel, a tensioning mechanism disposed on the first panel, and a fixed connecting band connecting to the transport mechanism. The transport mechanism is configured to move along the fixed connecting band such that the plurality of panels moves between a closed position and an open position. In the closed position, the plurality of panels is substantially received in the first straight portion. In the open position, the plurality of panels is substantially received in the second straight portion.

These and other advantageous features will become apparent to those reviewing the disclosure and drawings.

### BRIEF DESCRIPTION OF THE DRAWINGS

FIG. 1 shows a schematic exterior view of a garage door assembly according to one embodiment.

FIG. 2 shows a schematic interior view of the garage door assembly of FIG. 1.

FIG. 3 shows a schematic upward view of the garage door assembly of FIG. 1.

FIG. 4 shows a schematic detailed view of a motor mounted to a garage enclosure for the garage door assembly of FIG. 1.

FIG. 5 shows a schematic detailed view of a gear mechanism mounted to the garage enclosure for the garage door assembly of FIG. 1.

FIG. 6 shows a schematic detailed view of a tensioning mechanism and a quick release mechanism mounted to a first panel of the garage door assembly of FIG. 1.

FIG. 7 shows a schematic detailed view of a curved portion of a top rail of the garage door assembly of FIG. 1.

FIG. 8 shows a schematic detailed view of an entrapment shield for the garage door assembly of FIG. 1.

FIG. 9 shows a schematic detailed view of a bottom rail of the garage door assembly of FIG. 1.

FIG. 10A shows a cross-sectional view of the bottom rail of FIG. 9.

FIG. 10B shows a cross-sectional view of a bottom rail according to another embodiment.

FIG. 11 shows a schematic detail view of an entrapment shield according to another embodiment.

### DETAILED DESCRIPTION

Referring generally to the figures, disclosed herein is a garage door assembly capable of opening in a horizontal manner that meets the standards of U.S. consumer safety organizations, such as UL. Thus, embodiments of the present disclosure provide for a garage door assembly capable of operating in a safe and reliable manner, while providing a means for enclosing an opening for a garage enclosure that is larger in both width and height.

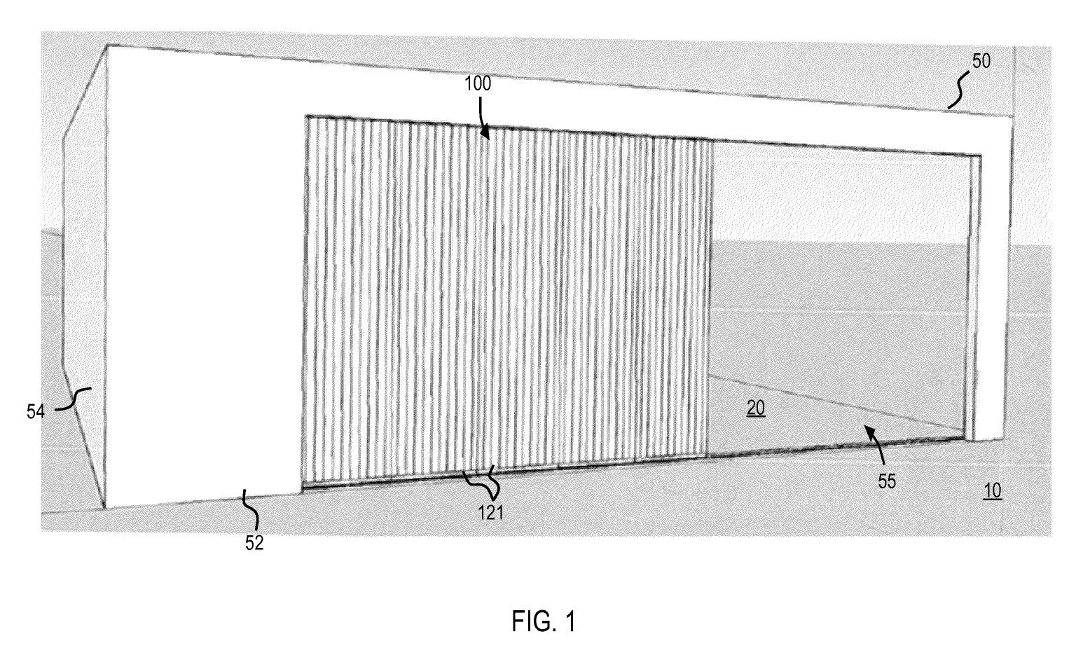

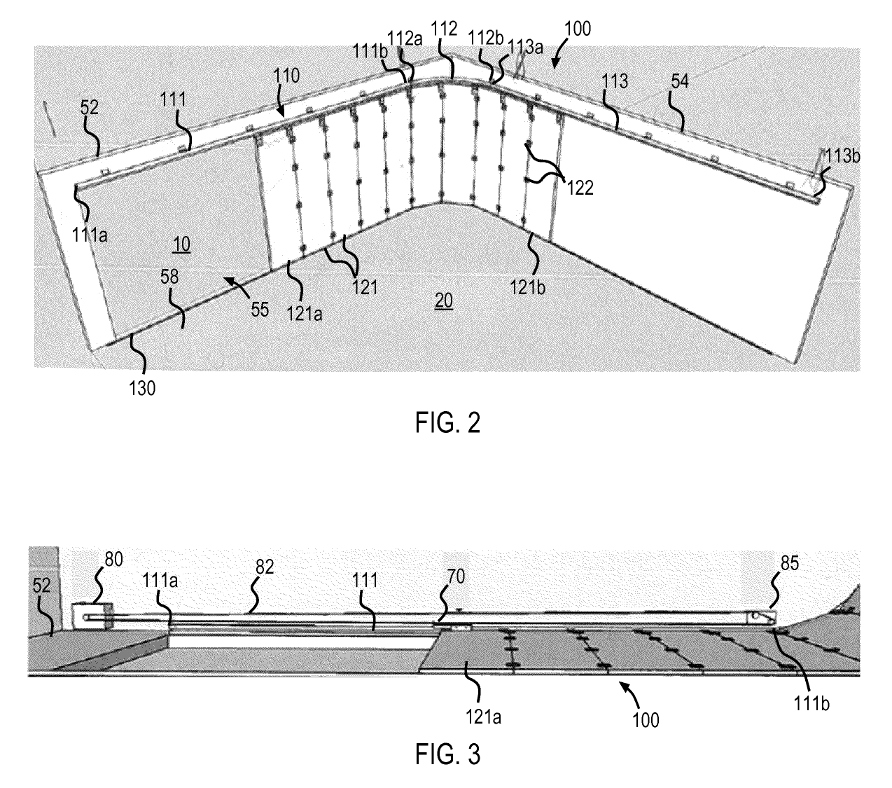

FIG. 1 shows a schematic exterior view of a garage door assembly according to one embodiment of the present invention, while FIG. 2 shows an interior view of the garage door assembly of FIG. 1. As shown in FIGS. 1 and 2, a garage enclosure 50 includes a back wall (not shown), two side walls (a first side wall 54 is shown), and a front wall 52 having an opening 55 for accessing an interior 20 of the garage enclosure 50 from an exterior 10. The garage door assembly 100 is configured to open and close the opening 55 to allow a user to enter or exit the interior 20 of the garage enclosure 50.

The garage door assembly 100 generally includes a top rail 110 extending along a length of the front wall 52 and first side wall 54, a bottom rail 130 extending along a length of a bottom surface or floor 58 of the garage enclosure 50, and a plurality of panels 121. The plurality of panels 121 are each received by the top rail 110 at top portions of the panels 121 and the bottom rail 130 at bottom portions of the panels 121. Adjacent panels 121 are pivotally connected to one another at vertically-extending side edges by one or more hinges 122.

As shown in FIG. 2, the top rail 110 is positioned above top edges of the plurality of panels 121 and includes a first straight portion 111, a curved portion 112, and a second straight portion 113. A first end 111a of the first straight portion 111 is mounted to the front wall 52 at a first end of the opening 55 and a second end 111b of the first straight portion 111 is mounted to the front wall 52 at a second end of the opening 55 such that the first straight portion 111 extends along the length of the opening 55. A first end 112a of the curved portion 112 is mounted to the front wall 52 to connect to the second end 111b of the first straight portion 111 while a second end 112b of the curved portion 112 is mounted to the first side wall 54 to connect to a first end 113a of the second straight portion 113. The second straight portion 113 then extends along the first side wall 54 and terminates at a second end 113b.

As shown in FIG. 3, the garage door assembly 100 further includes a motor 80, a driven gear mechanism 85, and a tensioning mechanism 70. A connecting band 82 operably connects the motor 80 to the driven gear mechanism 85 and attaches to the tensioning mechanism 70 to form a substantially closed loop along a length of the top rail 111.

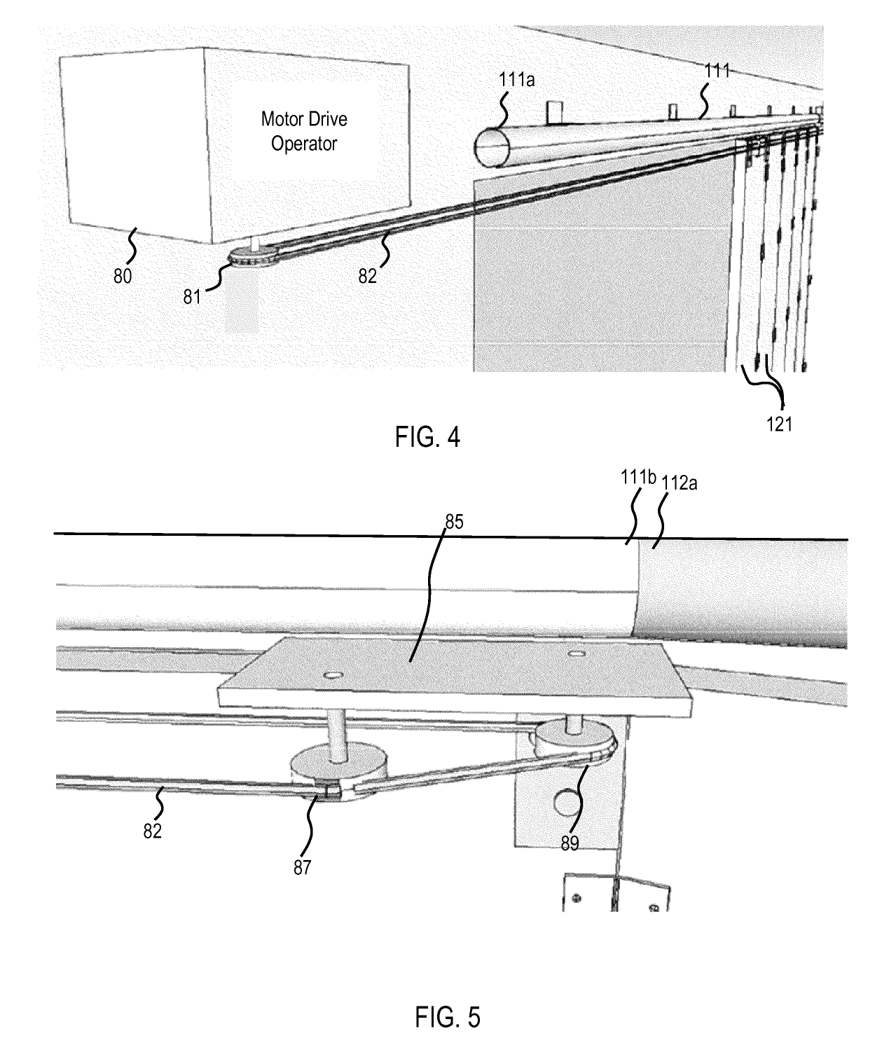

The motor 80 may be mounted to the front wall 52 or a ceiling of the garage enclosure 50 and positioned at the first end 111a of the first straight portion 111. As shown in FIG. 4, the motor 80 may include a drive gear mechanism 81 that is configured to receive the connecting band 82 (e.g., by grooves or gear teeth). During operation, the motor 80 rotates the drive gear mechanism 81 to drive the connecting band 82 such that the plurality of panels 121 move along the top rail 111 and bottom rail 130 to the open position or closed position. In certain embodiments, the motor 80 is a motor drive operator that meets applicable safety standards and includes safety features such as a photo sensor and impulse-actuated reversible switch in accordance with UL. The embodiments disclosed herein include all variations of inherent and external safety devices used to meet current or future safety requirements described by UL. For example, inherent safety devices include, but are not limited to, an impulse-actuated reversible switch. External safety devices include, but are not limited to, documentation and consumer notification, design, visual and audible warning devices, photo sensors, pressure sensors, and an external shield or wall.

As shown in FIG. 5, the driven gear mechanism 85 may be mounted to the front wall 52 or ceiling and may be positioned at the second end 111b of the first straight portion 111. The driven gear mechanism 85 includes a driven sprocket 89 and a tensioning sprocket 87, which are each configured to receive the connecting band 82 (e.g., by grooves or gear teeth). The tensioning sprocket 87 is linearly offset from the driven sprocket 89. During operation of the motor 80, the driven sprocket 89 is configured to rotate and be driven by the connecting band 82 due to the rotation of the drive gear mechanism 81. In addition, due to the linear offset of the tensioning sprocket 87, the tensioning sprocket 87 provides tension in the connecting band 82 as the band 82 is driven by the motor 80. In other embodiments, the motor 80 may be configured as a direct drive operator such that the connecting band 82 and driven gear mechanism 85 is not used. In such embodiments, the direct drive operator includes a transport mechanism (e.g., a carriage) affixed to a panel (e.g., a first panel 121 shown in FIG. 2). The transport mechanism is operably connected to and configured to move along a rail encasing a fixed connecting band (e.g., chain or belt). The transport mechanism moves along the fixed connecting band, providing movement of the plurality of panels 121 between open and closed positions.

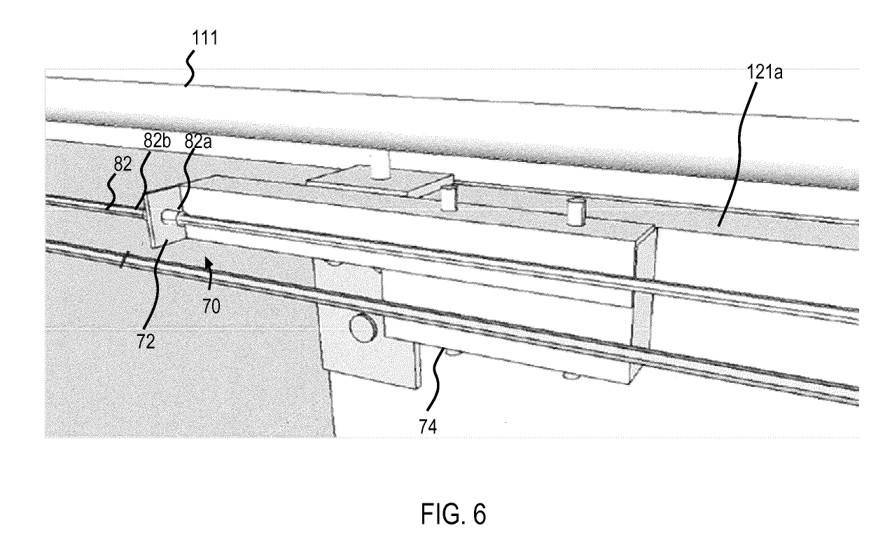

As shown in FIG. 6, the tensioning mechanism 70 is disposed along a top portion of a first panel 121a (as shown in FIG. 2, the first panel 121a may be, in some embodiments, a front panel or a leading panel). The tensioning mechanism 70 includes an attachment bracket 72 where a first end 82a of the connecting band 82 is attached to one side of the attachment bracket 72 and a second end 82b of the connecting band 82 is attached to the other side of the attachment bracket 72 to allow the motor 80 to push and pull the first panel 121a through the rotation of the drive sprocket 81. A quick release mechanism, such as a quick release bracket 74, may also be provided on the tensioning mechanism 70, which is configured to quickly release the tensioning mechanism 70 from the quick release bracket 74 (and, thus, the first panel 121a) in the event of a power failure of the motor 80. In certain embodiments, in the event of a release of the tensioning mechanism 70 from the quick release bracket 74, the first panel 121a may be provided with a handle, which allows a user of the garage door assembly 100 to manually move the plurality of panels 121 between the open position and the closed position.

Although shown that a first panel 121a positioned nearest the front wall 52 of the garage enclosure 50 when the plurality of panels 121 is in the open position (i.e., the front panel or the leading panel) is provided with the tensioning mechanism 70 to be pushed or pulled by operation of the motor 80, the motor 80, gear mechanism 85, and tensioning mechanism 70 may instead be positioned to push or pull a panel 121b (shown in FIG. 2) that is positioned furthest from the front wall 52 of the garage enclosure 50 when the plurality of panels 121 is in the open position (i.e., a last panel or non-leading panel). For example, the motor 80 may be mounted to the first side wall 54 at the second end 113b of the second straight portion 113 and the gear mechanism 85 may be mounted to the first side wall 54 at the first end 113a of the second straight portion 113. The tensioning mechanism 70 may then be disposed on the panel 121b and the connecting band 82 may operably connect the motor 80 to the gear mechanism 85 and attach to the tensioning mechanism 70. The motor 80 may then drive the connecting band 82 such that the plurality of panels 121 is pushed or pulled via the panel 121b (i.e., the last panel or non-leading panel).

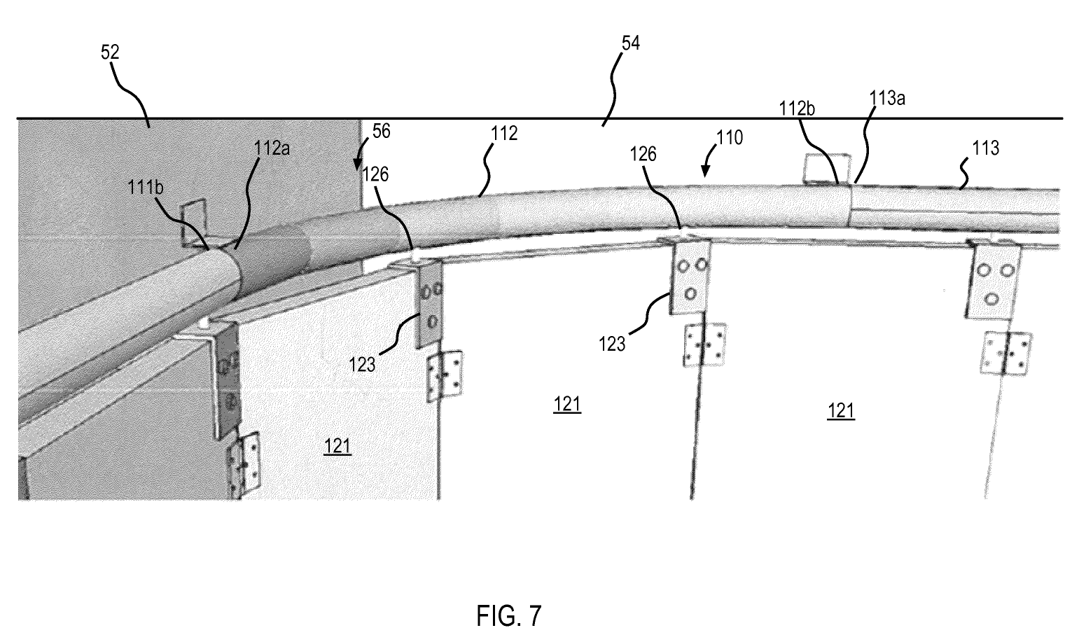

The motor 80 drives the connecting band 82 such that the plurality of panels 121 may be moved relative to the top rail 111 and the bottom rail 130 into a closed position, where the plurality of panels 121 is substantially received in the first straight portion 111, or an open position, where the plurality of panels 121 is substantially received in the second straight portion 113. In moving between the first straight portion 111 to the second straight portion 113, the plurality of panels 121 travels through the curved portion 112 of the top rail 110, as shown in FIG. 7. The curved portion 112 is configured to smoothly transition the plurality of panels 121 from being substantially parallel with the front wall 52 in the closed position to being substantially parallel with the first side wall 54 in the open position. For example, to provide a smooth transition, the curved portion 112 may be provided with a radius of curvature of about 18 inches in certain embodiments.

To further aid in providing smooth movement of the plurality of panels 121 in the top rail 110, each of the plurality of panels 121 may be provided with a hanging roller 126 mounted to top portions of the plurality of panels 121 with a bracket 123. The hanging rollers 126 are configured to be received and held within the top rail 110 and are movable with respect to the top rail 110 when the connection band 82 is driven by the motor 80. In some embodiments, the hanging rollers 126 may be in the form of ball rollers such that the plurality of panels 121 smoothly transition through the curved portion 112 between the first and second straight portions 111, 113.

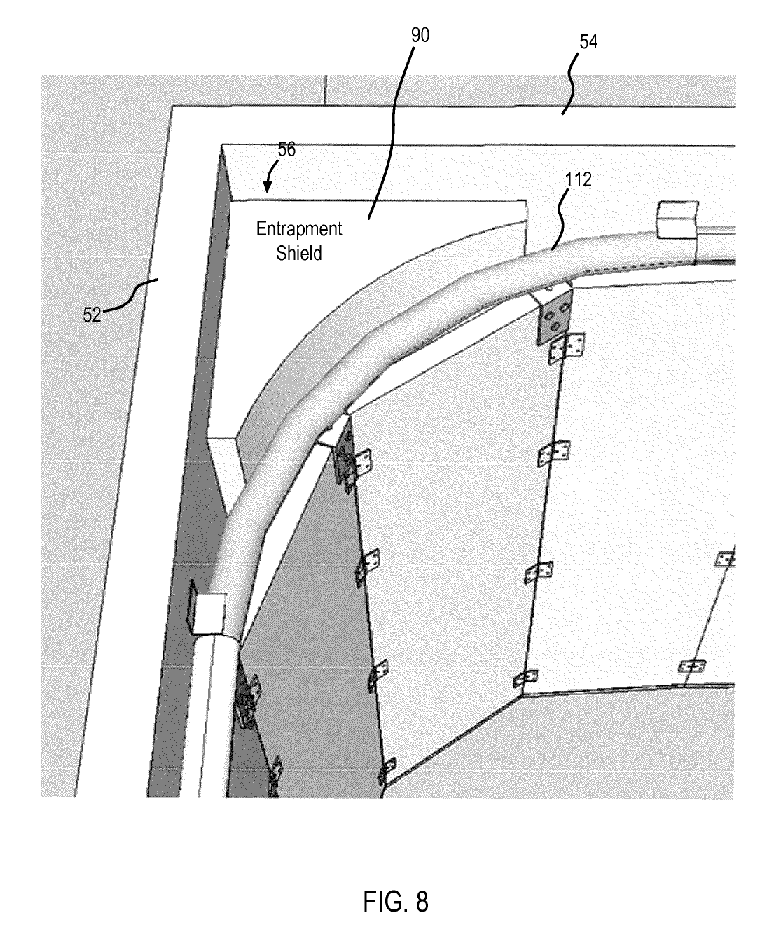

As further shown in FIG. 7, while the curved portion 112 is positioned and curved such as to closely follow the transition from the front wall 52 to the side wall 54 while still allowing for sufficient maneuverability of the plurality of panels 121 within the curved portion 112, a space 56 may remain between a back side of the plurality of panels 121 and corner area of the front wall 52 and the side wall 54. When such a space 56 remains, persons and/or objects may become entrapped within the space 56 during movement of the plurality of panels 121 within the curved portion 112. To prevent risk of entrapment, the space 56 may be provided with a shield wall 90, as shown in FIG. 8. The shield wall 90 includes side walls that are configured to be flush with the surfaces of the front wall 52 and the first side wall 54. In addition, the shield wall 90 includes a front wall that is shaped to conform to the curvature of the curved portion 112. In this manner, the shield wall 90 is configured to substantially fill the space 56 such that the risk for entrapment is substantially reduced.

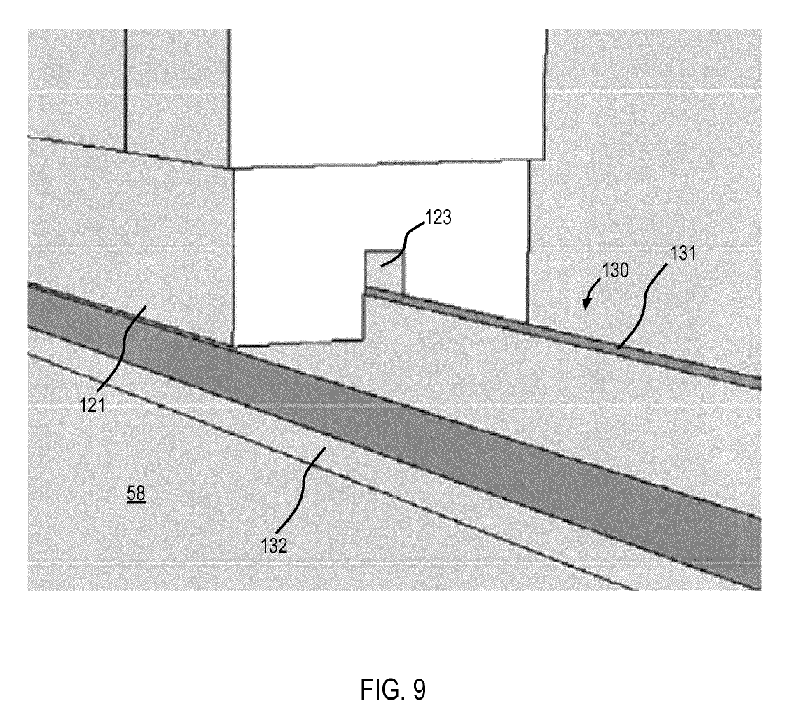

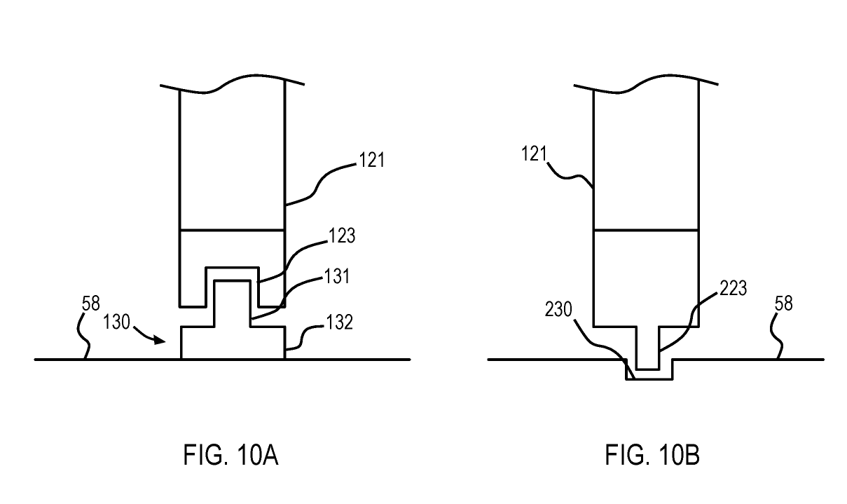

As discussed above, the bottom portions of the plurality of panels 121 are received by a bottom rail 130, which extends along a length of a floor 58 of the garage enclosure 50. The bottom rail 130 is configured to act as a guide for the plurality of panels 121 during movement of the panels and prevents side-to-side motion of the panels 121. As shown in FIGS. 9 and 10A, in some embodiments, the bottom rail 130 may comprise a base 132 having a central protrusion 131 protruding upwardly from the base along the length of the bottom rail 130. In addition, the bottom portions of the plurality of panels 121 may be provided with a central groove 123 configured to receive the central protrusion 131. In other embodiments, as shown in FIG. 10B, the base 132 of the bottom rail 130 may be formed by a groove 230 formed in the floor 58 of the garage enclosure 50, while a central protrusion 223 may be provided on the bottom ends of the plurality of panels 121 such that the central protrusion 223 is received into the groove 130 to reliably guide the plurality of panels 121 during movement.

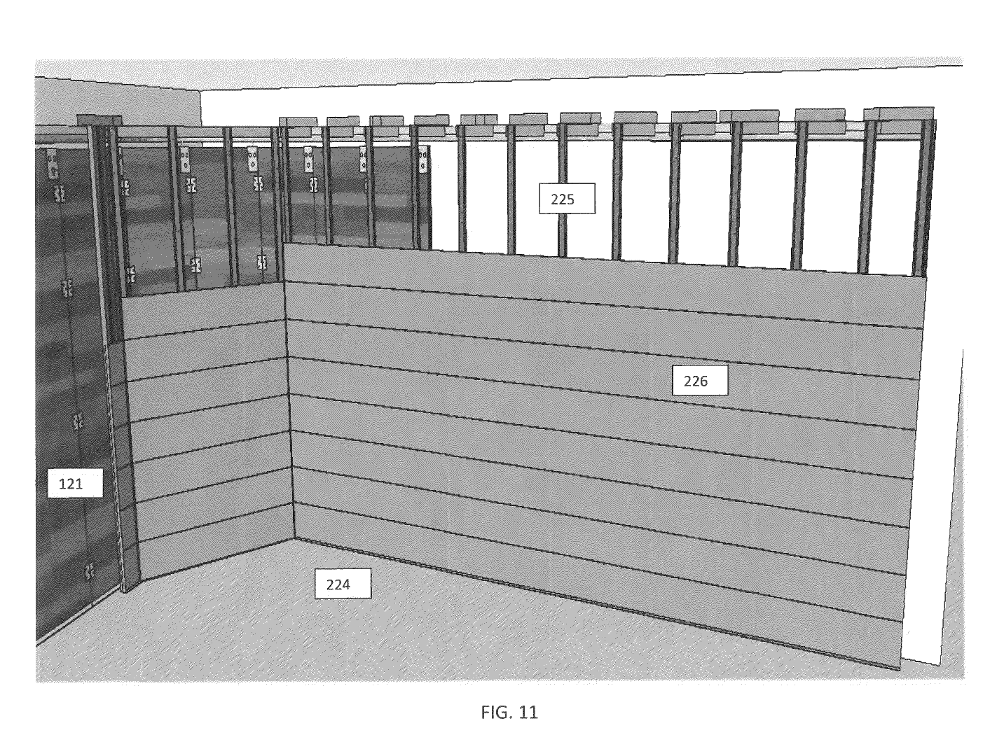

As further shown in FIG. 11, in addition to or in alternative to the entrapment shield shown in FIG. 8, an external entrapment shield 224 may be installed, which is configured to prevent entrapment of a user during movement of the garage door. In the embodiment shown in FIG. 11, the external entrapment shield 224 includes a plurality of supports 225 and a plurality of panels 226 attached to the plurality of supports 225. As shown in FIG. 11, in contrast to the entrapment shield shown in FIG. 8, the plurality of supports 225 and the plurality of panels 226 are placed on an external or front side of the plurality of panels 121 within the interior of the garage enclosure 50. The plurality of supports 225 and the plurality of panels 226 may be configured to extend along the second straight portion 113 and curved portion 112 of the top rail and attach to the front wall 52. When the plurality of panels 121 moves from the closed position to the open position, the plurality of panels 121 enter the space provided between the external entrapment shield 224 and the front wall 52 and first side wall 54. Although shown in one configuration in FIG. 11, the external entrapment shield 224 is not necessarily limited to the configuration shown in FIG. 11 and may instead be varied in any manner such that the plurality of panels 121 is externally shielded during movement.

The garage door assembly described herein provides a reliable and safe horizontally-opening garage door assembly. In addition, due to the horizontal manner in which the garage door opens, the assembly may not be significantly limited by the weight of panels, allowing a user to incorporate larger panels for a garage enclosure that is larger in both width and height. Moreover, the ceiling of the garage enclosure may remain clear of the various components of the assembly. In certain embodiments, to further enhance the aesthetic of the garage enclosure, a false wall may be provided along and spaced apart from the first side wall 54. The false wall and the first side wall 54 may create a pocket or tunnel for the plurality of panels 121 to enter as the panels are moved into the closed position. This, in turn, may provide additional safety features of the assembly as users are protected from movement of the panels along the side wall. In addition, available space within the enclosure may be enhanced as the false wall allows for the addition of storage or shelving on the false wall.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A garage door assembly comprising:
a plurality of panels, each of the plurality of panels having a top edge and a bottom edge and a pair of vertically-extending side edges connecting the top edge and the bottom edge, wherein adjacent panels are pivotally connected at adjacent side edges;
a top rail positioned above the top edges of the plurality of panels and configured to receive the plurality of panels, the top rail comprising:
a first straight portion;
a curved portion; and
a second straight portion,
wherein the curved portion connects the first straight portion and the second straight portion;
a motor positioned at a first end of the first straight portion;
a tensioning mechanism disposed on a first panel;
a driven gear mechanism positioned at a second end of the first straight portion; and
a connecting band connected to the motor and the driven gear mechanism and attached to the tensioning mechanism to form a loop along a length of the top rail,
wherein the motor is configured to drive the connecting band such that the plurality of panels moves between a closed position and an open position,
wherein, in the closed position, the plurality of panels is substantially received in the first straight portion, and
wherein, in the open position, the plurality of panels is substantially received in the second straight portion.

2. The garage door assembly of claim 1, wherein the motor comprises a drive gear mechanism configured to receive the connecting band.

3. The garage door assembly of claim 2, wherein the driven gear mechanism comprises a driven sprocket and a tensioning sprocket that are configured to receive the connecting band, and wherein the tensioning sprocket is linearly offset from the driven sprocket to provide tension to the connecting band as the connecting band is driven by the motor.

4. The garage door assembly of claim 3, wherein the connecting band is a belt.

5. The garage door assembly of claim 3, wherein the connecting band is a chain.

6. The garage door assembly of claim 1, further comprising a shield wall configured to be positioned along the curved portion of the top rail and on a back side of the plurality of panels.

7. The garage door assembly of claim 1, further comprising a shield wall configured to be positioned along the second straight portion and the curved portion and on a front side of the plurality of panels.

8. The garage door assembly of claim 1, further comprising a quick release mechanism, wherein the quick release mechanism is configured to release the tensioning mechanism from the first panel for manual operation of the plurality of panels.

9. The garage door assembly of claim 8, wherein the first panel comprises a handle configured to allow the plurality of panels to move from the closed position to the open position through manual operation.

10. The garage door assembly of claim 1, wherein each of the plurality of panels comprises at least one hanging roller configured to be received within the top rail.

11. The garage door assembly of claim 10, wherein the at least one hanging roller is a ball roller.

12. The garage door assembly of claim 1, further comprising a bottom rail configured to receive bottom portions of the plurality of panels.

13. The garage door assembly of claim 12, wherein the bottom rail includes a central protrusion and each of the bottom portions of the plurality of panels includes a central groove, and wherein the central protrusion is configured to be received within the central grooves of the bottom portions.

14. The garage door assembly of claim 12, wherein the bottom rail includes a groove and each of the bottom portions of the plurality of panels includes a central protrusion, and wherein the central protrusions of the bottom portions are configured to be received within the groove.

15. The garage door assembly of claim 1, wherein the curved portion comprises a radius of curvature of about 18 inches.

16. The garage door assembly of claim 1, wherein the first straight portion extends along a length of a front wall of a garage enclosure and the second straight portion extends along a length of a side wall of the garage enclosure, the front wall having an opening, and the plurality of panels being configured to close the opening when in the closed position.

17. The garage door assembly of claim 1, wherein the first straight portion extends along a length of a side wall of a garage enclosure and the second straight portion extends along a length of a front wall of the garage enclosure, the front wall having an opening, and the plurality of panels being configured to close the opening when in the closed position.

18. The garage door assembly of claim 16, wherein the first panel is a leading panel.

19. The garage door assembly of claim 17, wherein the first panel is a non-leading panel.

20. A garage door assembly comprising:
a plurality of panels, each of the plurality of panels having a top edge and a bottom edge and a pair of vertically-extending side edges connecting the top edge and the bottom edge, wherein adjacent panels are pivotally connected at adjacent side edges;
a top rail positioned above the top edges of the plurality of panels and configured to receive the plurality of panels, the top rail comprising:
a first straight portion;
a curved portion; and
a second straight portion,
wherein the curved portion connects the first straight portion and the second straight portion;
a transport mechanism disposed on a first panel;
a tensioning mechanism disposed on the first panel; and
a fixed connecting band connected to the transport mechanism;
wherein the transport mechanism is configured to move along the fixed connecting band such that the plurality of panels moves between a closed position and an open position,
wherein, in the closed position, the plurality of panels is substantially received in the first straight portion, and
wherein, in the open position, the plurality of panels is substantially received in the second straight portion.
